(19) United States
(12) Patent Application Publication
(10) Pub. No.: US 2023/0405884 A1
(43) Pub. Date: Dec. 21, 2023

(54) Method for Repairing Composite Materials Via Dielectric Barrier Discharge

(71) Applicants: The Texas A&M University System, College Station, TX (US); Essentium IPCO, LLC, Pflugerville, TX (US)

(72) Inventors: Anubhav Sarmah, Bryan, TX (US); Micah J. Green, College Station, TX (US); Smita Shivraj Dasari, College Station, TX (US); Daniel Carey, Austin, TX (US); Nirup Nagabandi, Pflugerville, TX (US)

(73) Assignees: The Texas A&M University System, College Station, TX (US); Essentium IPCO, LLC, Pflugerville, TX (US)

(21) Appl. No.: 18/337,173

(22) Filed: Jun. 19, 2023

Related U.S. Application Data
(60) Provisional application No. 63/353,840, filed on Jun. 20, 2022.

(51) Int. Cl. B29C 35/12; B29C 73/12

(52) U.S. Cl. CPC B29C 35/12; B29C 73/12; B29K 2063/00

(57) ABSTRACT

Provided herein is a method for repairing a composite material, a layup manufacturing process of a composite and a system for manufacturing a 3-dimensional composite part. The method, process and system all utilize a dielectric barrier discharge applicator to generate a plasma to cure an epoxy material to bond a patch to a composite material or to bond two or more layers of composite material together in a 3-dimensional shape to form a composite part.

### CROSS-REFERENCE TO RELATED APPLICATIONS

This non-provisional application claims benefit of priority under 35 U.S.C. § 119(e) of provisional application U.S. Ser. No. 63/353,840, filed Jun. 20, 2022, the entirety of which is hereby incorporated by reference.

### BACKGROUND OF THE INVENTION

### Field of the Invention

The present invention relates generally to the fields of composites and the manufacture and repair thereof. More specifically the present invention relates to methods of repairing composite materials via heating and curing a patch with a dielectric barrier discharge plasma.

### Description of the Related Art

Carbon fiber-reinforced composites (CFRCs) are ubiquitous in the defense and aerospace industries because they combine light weight with high tensile properties, thermal stability, and chemical resistance (1-3). These materials are typically processed using large autoclaves or ovens, first in a B-staging process to make partially cured prepregs, followed by lay-up in large molds to cure them completely (4). However, such composites require repair and maintenance due to wear and tear over their lifecycle or even due to damage in the line of duty. Damage may consist of holes, scratches, delamination, and dents due to small projectile impacts, hail, bird-strikes, and may also occur during maintenance (5-7). These affected areas lead to cracks in the specimen, and the propagation of such cracks often lead to complete failure of the part while in service. Thus, it is important to repair these parts to prolong their service life.

Common methods of repairing these composites include using external metal fasteners and using a tapered scarf of reinforcing material to fill in the damaged area (9). External metal fasteners provide support to the damaged composite by holding it together, but they do not offer a permanent solution because there is a tendency of concentrating additional stress across the composite at the points where the fasteners are fixed. The fasteners could also slip and fall off the composite (10). Using a tapered scarf involves cutting out pieces of reinforcing material in circular strips which are then placed carefully along the inside of the crack or damaged area (11). The crack is then filled slowly, layer by layer, where each subsequent layer has a larger area than the previous layer. The effectiveness of this method largely depends on the skill and expertise of the operator (12). To repair using a scarf, excess material needs to be excavated from the damaged area. This requires special equipment such as a pneumatic router or grinder and surface profiling equipment (13). These disadvantages have limited the applicability of external metal fasteners and scarves for composite repair.

Recently, patching has been explored as a possible solution for repair of damaged composites (8,14,15). This is one of the easiest methods to repair carbon fiber-reinforced composites (16,17). The patches can be fully cured carbon fiber-reinforced composite panels or partially cured prepregs (18). In the case of patches, epoxy and acrylic resins act as adhesives and are used to attach these patches to the damaged part, typically via application of heat. A fully cured composite, however, could peel off from the damaged area if the adhesive fails. On the other hand, patching using partially cured prepregs leads to higher interfacial strength, which in turn leads to a more effective repaired part performance, compared to a fully cured composite patch (19).

The key difficulty in using either patching method is supplying heat to the damaged zone to cure the prepreg patch or/and adhesive (20). Conventional methods of heating during patching involve using ovens and autoclaves (21,22). Recently, the use of microwaves for heating patches was explored; however this method can be used only for relatively smaller parts which can be placed inside a microwave oven (23). In the field, hot air guns and heating blankets provide a portable solution (24,25).

Recently, it was shown that carbon fibers rapidly heat in response to non-contact electric fields (26,27), and the fabrication of carbon fiber prepregs and composites using radio-frequency heating was demonstrated (28,29). This is because these electric fields induce electric currents in the conductive susceptors, which in turn results in Joule heating (30). Various other applications of radio-frequency heating of carbon materials also have been explored, such as rapid manufacturing of thermoset nanocomposites (31,32), curing pre-ceramic polymer composites (33), bonding thermoplastic surfaces together (34) and reduction of graphene oxide (35).

A method for rapid repair and patching of composites is highly desirable, especially if this repair can be undertaken in the field, away from large processing centers, autoclaves, and equipment. Thus there is a need in the art for improved methods for a rapid out-of-oven patching and repair of composite materials. Specifically, the prior art is deficient in methods of patching and repairing composites via a dielectric barrier discharge—generated plasma for in situ heating and curing thereof. The present invention fulfills this longstanding need and desire in the art.

### SUMMARY OF THE INVENTION

The present invention is directed to a method for repairing a composite material. In this method, an epoxy is applied to an area of the composite material in need of repair and the area is covered with an epoxy-filled patch. The epoxy is cured electromagnetically, thereby repairing the composite material.

The present invention is further directed to a layup manufacturing process of a composite part. In this manufacturing process, an epoxy is applied to a first layer of composite material and a second layer of composite material is laid onto the first layer to shape the composite material as a layup, where the epoxy is disposed between the first layer and the second layer. The epoxy is heated to cure it to bond the first layer to the second layer in the layup to form the composite part.

The present invention is directed further to a system for manufacturing a 3-dimensional composite part. The system comprises a supply of a prepreg composite material stored on a spool and a supply of an epoxy material. An extruder is configured to dispense the prepreg composite material and the epoxy material. A dielectric barrier discharge applicator is positioned proximal to the extruder and is configured to generate a plasma to resistively heat the prepreg composite material and to cure the epoxy material as they are dispensed by the extruder, where the 3-dimensional composite part is formed thereby.

Other and further aspects, features, and advantages of the present invention will be apparent from the following description of the presently preferred embodiments of the invention. These embodiments are given for the purpose of disclosure.

### BRIEF DESCRIPTION OF THE DRAWINGS

So that the matter in which the above-recited features, advantages and objects of the invention, as well as others which will become clear, are attained and can be understood in detail, more particular descriptions of the invention briefly summarized above may be had by reference to certain embodiments thereof which are illustrated in the appended drawings. These drawings form a part of the specification. It is to be noted, however, that the appended drawings illustrate preferred embodiments of the invention and therefore are not to be considered limiting in their scope.

FIGS. 1A-1B show a Dielectric Barrier Discharge (DBD) applicator connected to a power supply and generating an electric field plasma (FIG. 1A) applied to a carbon fiber (FIG. 1B).

FIG. 2 shows the maximum temperature observed for unidirectional T700 carbon fiber tows when exposed to dielectric barrier discharge-generated plasma.

FIG. 3A shows through-plane AC Conductivity of carbon fiber tows and weaves as a function of frequency.

FIG. 3B shows the initial heating rates of carbon fibers when exposed to DBD-generated plasma with varying duty cycles.

FIGS. 3C-3E show the maximum temperature observed for unidirectional IM7 fibers (FIG. 3C), cross-weave IM7 fibers (FIG. 3D) and cross weave T300 fibers when exposed to dielectric barrier discharge-generated plasma (FIG. 3E).

FIGS. 4A-4B are XPS survey spectra of T700 unidirectional carbon fibers before exposing to plasma (FIG. 4A), and after exposing to plasma (FIG. 4B).

FIGS. 4C-4D are the deconvoluted XPS spectra of carbon fibers before exposure to plasma (FIG. 4C) and after exposure to plasma (FIG. 4D).

FIGS. 4E-4F show the O1s XPS spectra deconvolution of carbon fibers before (FIG. 4E) and after exposure to dielectric barrier discharge generated plasma (FIG. 4F).

FIG. 5A show DSC curves of resin-impregnated carbon fibers that have been exposed to dielectric barrier discharge-generated plasma for different residence times, maintained at a constant temperature of 120° C. by modulating the duty cycle.

FIG. 5B shows the degree of cure and glass transition temperature of prepregs exposed to dielectric barrier discharge plasma at 120° C.

FIGS. 6A-6E are schematics showing plasma-assisted patch repair of damaged composites. FIG. 6A is a carbon fiber composite with crack. FIG. 6B shows the crack filled with liquid epoxy FIG. 6C shows a prepreg patch (0.7 mm thickness) placed on top of the crack. In FIG. 6D the composite with patch is exposed to the dielectric barrier discharge generated plasma. FIG. 6E shows the patched composite.

FIG. 7A is a digital image of a prepreg patch, damaged composite, and sample repaired using dielectric barrier discharge-generated plasma at T=120° C.

FIGS. 7B-7C are micro-CT scans of carbon fiber composites showing a damaged composite with a crack (FIG. 7B) and a sample patched using dielectric barrier discharge-induced heating and curing with a zoomed CT scan image of the patch over the damaged area (FIG. 7C).

FIG. 8A shows the tensile strength of as-received carbon fiber composite, carbon fiber composite with crack, carbon fiber composite patched using DBD and carbon fiber composite patched using an oven.

FIG. 8B shows the lap shear strength of a carbon fiber composite patched with dielectric barrier discharge and a carbon fiber composite patched in an oven. In both the dielectric barrier discharge curing process and oven curing process, the patch was heated at 120° C. for 5 minutes (duty cycle: 40-60%) to completely cure it.

### DETAILED DESCRIPTION OF THE INVENTION

As used herein, the articles “a” and “an” when used in conjunction with the term “comprising” in the claims and/or the specification, may refer to “one”, but it is also consistent with the meaning of “one or more”, “at least one”, and “one or more than one”. Some embodiments of the invention may consist of or consist essentially of one or more elements, components, method steps, and/or methods of the invention. It is contemplated that any composition, component or method described herein can be implemented with respect to any other composition, component or method described herein.

As used herein, the term “or” in the claims refers to “and/or” unless explicitly indicated to refer to alternatives only or the alternatives are mutually exclusive, although the disclosure supports a definition that refers to only alternatives and “and/or”.

As used herein, the terms “comprise” and “comprising” are used in the inclusive, open sense, meaning that additional elements may be included. The terms “consists of” and “consisting of” are used in the exclusive, closed sense, meaning that additional elements cannot be included. Use of “comprise” or “comprising” in a claim does not preclude changing or amending to “consists of” or “consisting of”.

As used herein, the term “including” is used herein to mean “including, but not limited to”. “Including” and “including, but not limited to” are used interchangeably.

As used herein, the conditional language, such as, among others, “can”, “might”, “may”, “e.g.”, “for example”, and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

As used herein, the terms “composite material” and “composite”, either in the singular or the plural, are used interchangeably.

As used herein, the term “composite part” refers to a 3-dimensional object made from or comprising a composite material that is a stand-alone part or is a part of a larger object or structure which in addition to the composite part may itself comprise a composite material.

In one embodiment of the present invention, there is provided a method for repairing a composite material, comprising applying an epoxy to an area of the composite material in need of repair; covering the area with an epoxy-filled patch; and curing the epoxy electromagnetically, thereby repairing the composite material.

In an aspect of this embodiment, the curing step may comprise exposing the composite material and the epoxy-filled patch to a plasma produced by an electromagnetic applicator; heating inductively via the plasma the composite material and the epoxy-filled patch; and transferring heat from the composite material and the epoxy-filled patch to the epoxy contained therein to cure the same. In this aspect, the electromagnetic applicator may be a dielectric barrier discharge applicator that comprises a pair of electrodes and a dielectric layer and an air gap positioned to separate the electrodes so that current flowing through the pair of electrodes flows through the dielectric layer to generate the plasma. Also in this aspect the dielectric barrier discharge applicator may be a hand-held dielectric barrier discharge applicator. In addition, the dielectric barrier discharge applicator does not make physical contact with the composite material during the exposing step.

In this embodiment and aspects thereof the composite material may be a carbon fiber reinforced composite material, a crossweaved carbon fiber reinforced composite material, or a hybrid composite consisting of carbon fibers and carbon nanomaterials Also the epoxy-filled patch may be made of a carbon fiber, a heat-sensitive thermosetting epoxy, or nanomaterials for additional reinforcement. In addition the area of the composite material in need of repair may be repaired in situ. Furthermore, the composite material in need of repair may be a component of a 3-dimensional composite part.

In another embodiment of the present invention there is provided a layup manufacturing process of a composite part, comprising applying an epoxy to a first layer of composite material; laying a second layer of composite material onto the first layer to shape the composite material as a layup, the epoxy disposed between the first layer and the second layer; and heating the epoxy to cure it to bond the first layer to the second layer in the layup to form the composite part.

In an aspect of this embodiment the heating step may comprise positioning a dielectric barrier discharge applicator proximal to the layup, where the dielectric barrier discharge applicator comprises a pair of electrodes with a dielectric layer and air gap positioned therebetween; heating resistively the composite material in the layup with a plasma produced when an electric current is applied across the pair of electrodes in the dielectric barrier discharge; and transferring heat from the composite material in the layup to the epoxy to cure the same in the shape of the composite part.

In this aspect the dielectric barrier discharge applicator may be stationary. Alternatively, the dielectric barrier discharge applicator may be movable relative to the layup. Also the dielectric barrier discharge applicator may be a hand-held dielectric barrier discharge applicator.

Further to this embodiment and aspects thereof, prior to the heating step, the method may comprise repeating the applying step and the laying step at least once until the composite material is shaped as the composite part. Also in both embodiments and aspects thereof the composite material may be a carbon fiber reinforced composite material or a composite material filled with carbon nanotubes, carbon black or chopped fibers.

In yet another embodiment of the present invention there is provided a system for manufacturing a 3-dimensional composite part, comprising a supply of a prepreg composite material stored on a spool; a supply of an epoxy material; an extruder configured to dispense the prepreg composite material and the epoxy material; and a dielectric barrier discharge applicator positioned proximal to the extruder configured to generate a plasma to resistively heat the prepreg composite material and to cure the epoxy material as they are dispensed by the extruder, where the 3-dimensional composite part is formed thereby.

In this embodiment the prepreg composite material may be a carbon fiber reinforced composite material. Also in this embodiment the dielectric barrier discharge applicator may comprise a pair of electrodes with a dielectric layer and air gap positioned therebetween.

Provided herein is a method or process of repairing cracks or damage points in composite materials using dielectric barrier discharge generated plasma induced heating and curing. Generally, an epoxy-impregnated patch or prepreg is applied on the cracked or affected area of a composite to mitigate the damage. The dielectric barrier discharge applicator is proximally positioned near the patch and generates an electric field plasma whereby the conductive fibers, for example, carbon fibers, are exposed to this plasma, and an electric current is induced which leads to resistive heating in the conductive fibers of the composite and the patch. This heat from the fibers is transferred to the surrounding epoxy, thus curing the patch and repairing the damage. Patches applied using dielectric barrier discharge eliminate the need for oven-heating, but are mechanically strong and stable and are comparable to conventional patches applied using oven heating. The patch prevents the crack from further propagating, and mitigates the danger of mechanical failure in the composite material or composite part. However, the implementation of the patches using the dielectric barrier discharge applicator method is much simpler, faster, and less expensive than conventional repairs. Moreover, the methods and processes provided herein may be performed without the dielectric barrier discharge applicator contacting the composite materials being repaired, which reduces the risk that the materials will be damaged during the repair.

In non-limiting examples, the composite material is a carbon fiber reinforced composites (CFRCs) and the patch is a carbon fiber/epoxy composite patch. The epoxy used in these methods and processes may be any commercial heat-sensitive thermoset. It is contemplated that the methods and processes provided herein may enable repair of other materials, for example, epoxy nanocomposites, thermoplastic nanocomposites, fiber-nanomaterial hybrid composites or carbon fiber-glass fiber hybrid composites.

More particularly, the dielectric barrier discharge applicator uses a high-voltage potential applied across a pair of electrodes that are separated by a solid dielectric layer and an air gap. In some aspects, the composite material itself is brought to the same voltage potential as one of the electrodes so that the material acts as an extension of the electrode. The solid dielectric layer prevents electron flow between the electrodes, suppressing electron discharges in favor of distributed filamentary plasma, diffuse-glow plasma, or Townsend discharges. The dielectric barrier discharge applicator has the unique ability to not damage temperature-sensitive materials due to the relatively low temperature of the plasma gas. However, the use of a dielectric barrier discharge applicator in proximity to materials containing carbon fiber, for example, carbon-fiber containing composites results in in situ, resistive heating of the carbon fiber.

The dielectric barrier discharge applicator may be stationary, moving, or portable, for example, hand-held or part of a mobile system. For a stationary dielectric barrier discharge applicator, the composite part moves relative to the dielectric barrier discharge applicator to expose all of the epoxy to the electric field generated by the dielectric barrier discharge applicator. The composite part may be held by a user and articulated around the dielectric barrier discharge applicator, situated on a moving table or conveyor, attached to a moving armature that positions the composite part relative to the dielectric barrier discharge applicator, or processed from a roll of prepreg that is unspooled by the dielectric barrier discharge applicator. For a moving dielectric barrier discharge applicator, the composite part may be stationary and the dielectric barrier discharge applicator is moved about the composite part to expose all of the epoxy to the electric field generated by the dielectric barrier discharge applicator. For a hand-held dielectric barrier discharge applicator, a user moves the dielectric barrier discharge applicator about the composite part to expose all of the epoxy to the electric field.

The methods and processes provided herein may be implemented with a dielectric barrier discharge applicator or a dielectric barrier discharge system that is mobile/transportable, for example, as a hand-held device, a piece of mobile equipment that can be transported by truck or trailer, etc. to the location of the composite part. The ability to bring the dielectric barrier discharge applicator to the composite part is particularly desirable when the part to be repaired is large, such as, but not limited to, an aircraft component. An added benefit of the mobility of the dielectric barrier discharge applicator is that some repairs may be made to composite parts or materials without having to remove the composite part from a larger assembly, saving time and labor. A portable, handheld dielectric barrier discharge applicator enables mobility where a user, for example, but not limited to, a repair technician, can effect repairs in the field or at the location of the damaged part.

The repair process provided herein may be used to repair damaged composite materials or parts in aerospace industries, in shipping industries, in the military, and in carbon neutral and carbon negative industries or in the field. In non-limiting examples the repair process is useful for the direct repair of fiber composite on ships docked or on the open water, for the direct repair of field deployed vehicles and equipment, for example, as deployed by the military, is useful in the aerospace industry for cheaper, faster repair of fuselages and other fiber composite parts, and is useful in carbon neutral and carbon negative industries as the process saves energy and also reduces waste by repairing existing layups without the need to throw away otherwise usable materials.

Also provided is a system and method or process for layups manufacturing of composite parts. In a non-limiting example, two or more layers of composite may be laid up with epoxy applied between the layers. The dielectric barrier discharge applicator is positioned proximal to the composite layers and an electric field is generated. Similar to the repair method or process, the composite layers interact with the electric field and become heated. The epoxy absorbs some of this heat and the curing process is expedited. This method of layup manufacturing may be performed with a dielectric barrier discharge applicator that is stationary, moving, or hand-held as described supra.

The following examples are given for the purpose of illustrating various embodiments of the invention and are not meant to limit the present invention in any fashion.

### EXAMPLE 1

### Methods and Materials

### Materials

The carbon fibers are unidirectional T700 (Toray), cross-weave IM7 (Hexcel), unidirectional IM7 (Hexcel), and cross-weave T300 (Toray). The patch is made of a two-part thermosetting epoxy consisting of EPON 828 (Hexion) and Jeffamine T403 (Huntsman Corp), and unidirectional T700SC-12K-50C (Toray) carbon fibers. The composite that was damaged and repaired was made from EPON 862 (Hexion) epoxide cured with Epikure W (Miller-Stephenson, Danbury, CT), and cross-weave IM7 (Hexcel, Stamford, CT) fibers.

### DBD Experiments

The Dielectric Barrier Discharge applicator consists of a metallic electrode embedded in a dielectric ceramic disc (36). The ceramic disc is about 3 mm thick, and 70 mm wide. A 24 V Direct Current (DC) power signal generated using NICE-POWER DC Power Supply (Model: R-SP53010) was supplied to the DBD applicator to generate plasma between the bottom of the dielectric disc and a ground plate underneath. 24 V is supplied to a high ratio winding transformer, which is then connected to the final ceramic applicator. The entire process takes place in air. Different grades of carbon fibers were exposed to DBD-generated plasma at a uniform spacing of 3-5 mm between the top electrode and the sample. The frequency of the output signal is ˜30 kHz. The temperature varied with time as the fibers were exposed to the plasma at different duty cycle values and was recorded using a FLIR A655sc model thermal camera, which has an error of ±1° C. An emissivity value of 0.95 was used for all FLIR measurements, which is the standard for most non-reflective non-metals.

Next, for fabrication of prepregs and composites, unidirectional T700 fibers impregnated with uncured epoxy were exposed to plasma for different times, keeping the target temperature constant at 120° C.; the duty cycle was modulated between 40-60% (with DC power supply fixed at 24 V), which corresponds to an average power value of 50-60 W. A software interface allows the user to connect with the dielectric barrier discharge and thus manually control the duty cycle. For practical, commercial applications, a mapping between input power sequence and output temperature would be utilized rather than a feedback loop.

Finally, for the patching experiments, cracks of width 1 mm and depth 0.4 mm were introduced in cross-weave carbon fiber composites with dimensions 60 mm×8 mm×0.8 mm. A carbon fiber prepreg was placed over the damaged area of the composite, and the entire system was exposed to DBD until the prepreg cured completely (˜5 min).

### Oven (Conventional Heating) Experiments

For comparison to the plasma assisted repair process, cross-weave carbon fiber composites (60 mm×8 mm×0.8 mm) were also repaired using a conventional oven for heating and curing of the prepreg patch at 120° C. temperature. The entire system was placed in the oven until the prepreg cured completely (˜5 min).

### Dielectric Spectroscopy

The through-plane AC conductivities of the carbon fibers were found using a Novocontrol Technologies dielectric spectrometer, within the frequency range of 0.1 Hz to 10 MHz. The samples were sandwiched between a 1 cm-diameter top electrode and a larger bottom electrode. Measurements were carried out at room temperature. The sample used in this measurement had a thickness of ˜0.6 mm.

### Differential Scanning Calorimetry

Differential scanning Calorimetry (DSC) was used to determine the degrees of cure and glass transition temperatures of the samples. A TA Instruments DSC Q20 (New Castle, DE) was used for these tests. The samples consisted of approximately 3-5 mg of material. The test chamber was purged with nitrogen at 50 mL/min. The ramp rate was set to 3° C/min, and the temperature was ramped from room temperature to 200° C.

### Micro-CT (Computed Tomography)

Damaged and patched specimens were micro-CT scanned using the NorthStar Imaging X50 micro-CT system (Rogers, MN) at the Texas A&M University Cardiovascular Pathology Laboratory (College Station, TX). Each scan was reconstructed with a resolution of approximately 19.3 microns using NorthStar Imaging efX software.

### Mechanical Testing

Composites of dimensions 5 cm×1 cm repaired using dielectric barrier discharge-generated plasma-induced heating and curing were mechanically tested to measure tensile strength and modulus, according to ASTM D3039 standard. For lap shear measurements, samples with an overlap area of 1 cm×1 cm were tested. An MTS Insight Electromechanical Testing System with a 30 kN load cell was used to apply tensile force on the sample until failure; the displacement rate was set at 2 mm/min for all tests. Composite repaired using conventional oven heating was used as the control specimen for these tests.

### X-Ray Photoelectron Spectroscopy

XPS measurements were performed using an Omicron XPS system with Mg X-ray source. Desized T700 fibers before and after exposing to DBD-generated plasma were used for XPS analysis. High resolution XPS spectra f constituent elements were utilized to compute relative atomic composition using CasaXPS software, version 2.3.22. Peak fitting was performed using symmetric Gaussian-Lorentzian curves (GL30). The C1s spectrum was deconvoluted into three components including C—C, C—O—C, and O—C═O.

### EXAMPLE 2

### DBD-Generated Plasma Induced Heating Behavior of Carbon Fibers

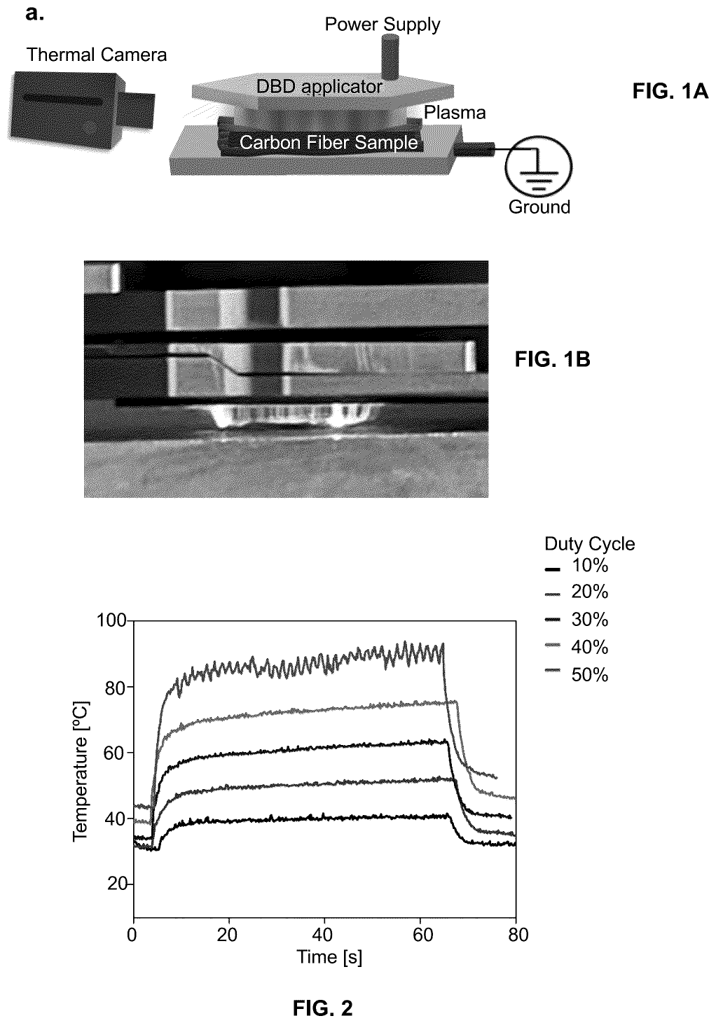

The electric field is generated by applying a pulsating DC signal to a metallic electrode embedded in a dielectric disc (FIG. 1A). The electric field ionizes the air between the dielectric disc and the sample. This ionized air can be seen as purple micro discharges or filamentous plasma generated between the dielectric disc and the top of the sample (FIG. 1B). The electric field acts as the initiator for the electron collision ionization, which induces currents in the conductive sample. Detailed characterization related to the DBD-generated plasma is found in a previous publication (36). The heating response of the sample exposed to the Dielectric Barrier Discharge (DBD)-generated plasma was monitored using a FLIR thermal camera. Previously, radio-frequency (RF) electric fields were used to heat and cure resins. RF fields do not have plasma discharge associated with them. Herein, the plasma and the electric field are coupled, and the plasma behaves as a means to apply the electric field (29,31,32).

First, T700 unidirectional carbon fibers were exposed to the dielectric barrier discharge-generated plasma to determine their responsiveness to the plasma. The fibers showed rapid heating. This is because the plasma arcing between the top electrode and the conductive sample allows for non-contact charge transfer from the top electrode into the sample. The sample is in contact with the ground electrode, which again allows for charge flow between them, thus completing the circuit. During plasma assisted heating, the ground electrode itself does not experience any heating. The initial heating rate and steady state temperatures of the T700 unidirectional carbon fibers when exposed to dielectric barrier discharge-generated plasma at different duty cycles (power supplied is directly proportional to the duty cycle) was determined. As the fibers begin to couple with the plasma, Joule heating is observed, and the temperature of the fibers increases quickly and reaches a steady state temperature. There is a rise in the steady state temperature of the fibers with an increase in the duty cycle (FIG. 2). This shows that the duty cycle of the dielectric barrier discharge-generated plasma can be modulated to reach a required target temperature of the fibers, and the fibers can be maintained at that temperature. The plasma itself is at room temperature, and the increase in temperature occurs due to the coupling of the carbon fibers with the plasma, thus inducing Joule heating in the fibers.

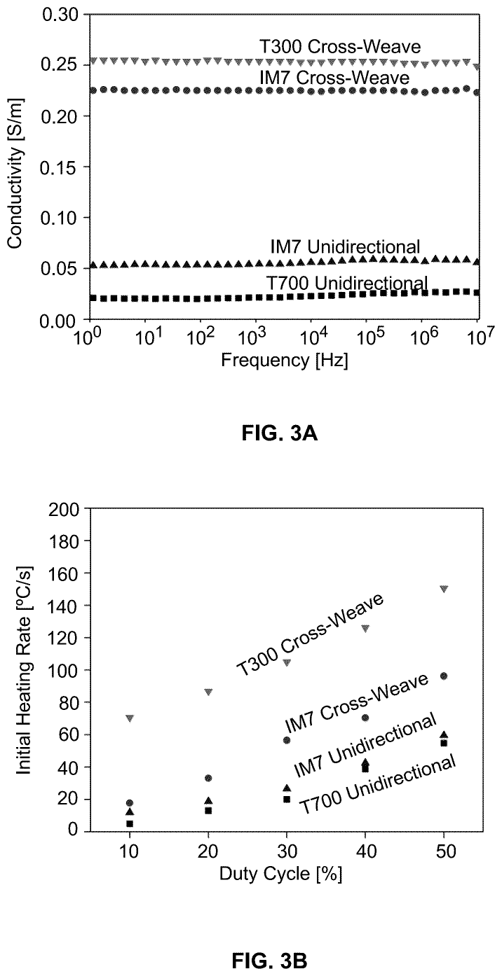

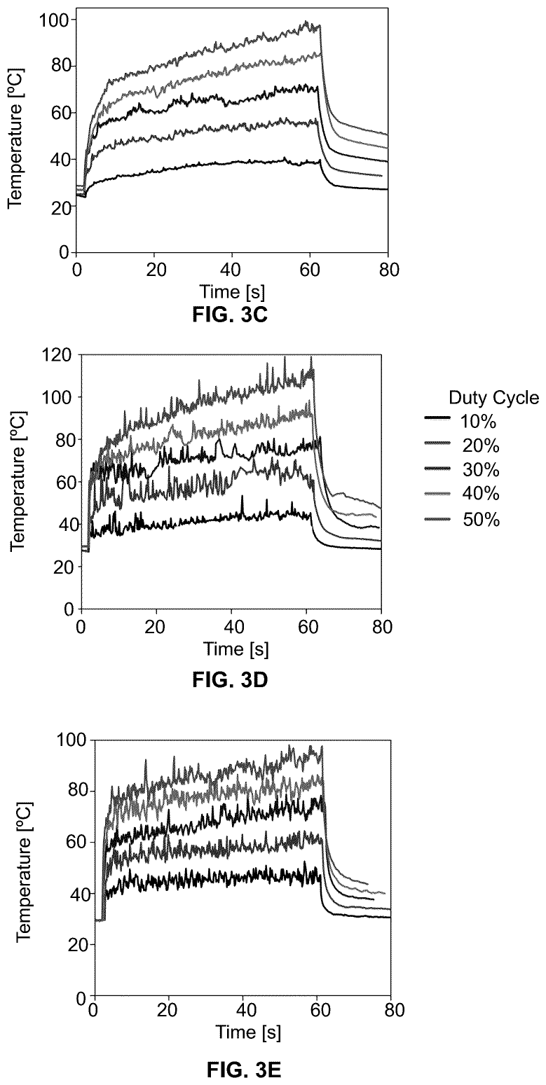

Next, the effect of conductivity on the heating rate for carbon fibers exposed to the dielectric barrier discharge was examined. The through-plane AC conductivity (FIG. 3A) of three different grades of carbon fibers was measured: T700, IM7, and T300, was measure and observed their heating response when exposed to DBD-generated plasma (FIG. 3B) was observed. The heating rates of fibers were found to be directly proportional to their through-plane AC conductivities; higher conductivity results in higher heating rate when exposed to plasma. The raw temperature-time data for different grades of carbon fibers are shown in FIGS. 3C-3E. T300 fibers' high conductivity results in significantly higher heating rate compared to the other grades of fiber. Note that it is the through-plane conductivity that matters because that is the direction of the electric current (top-to-bottom).

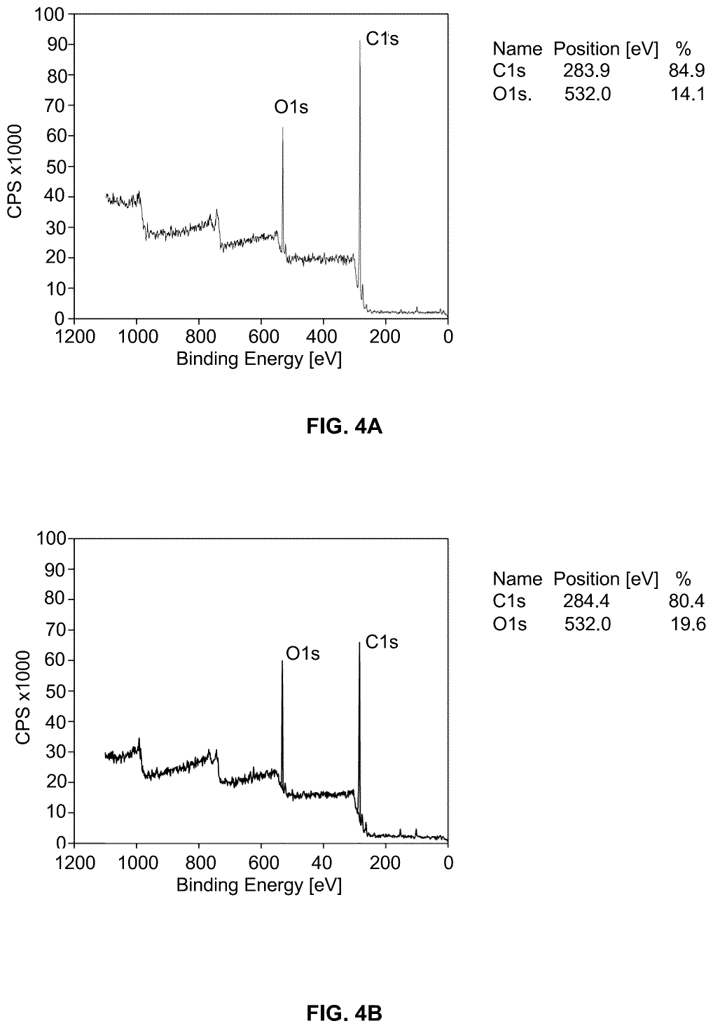

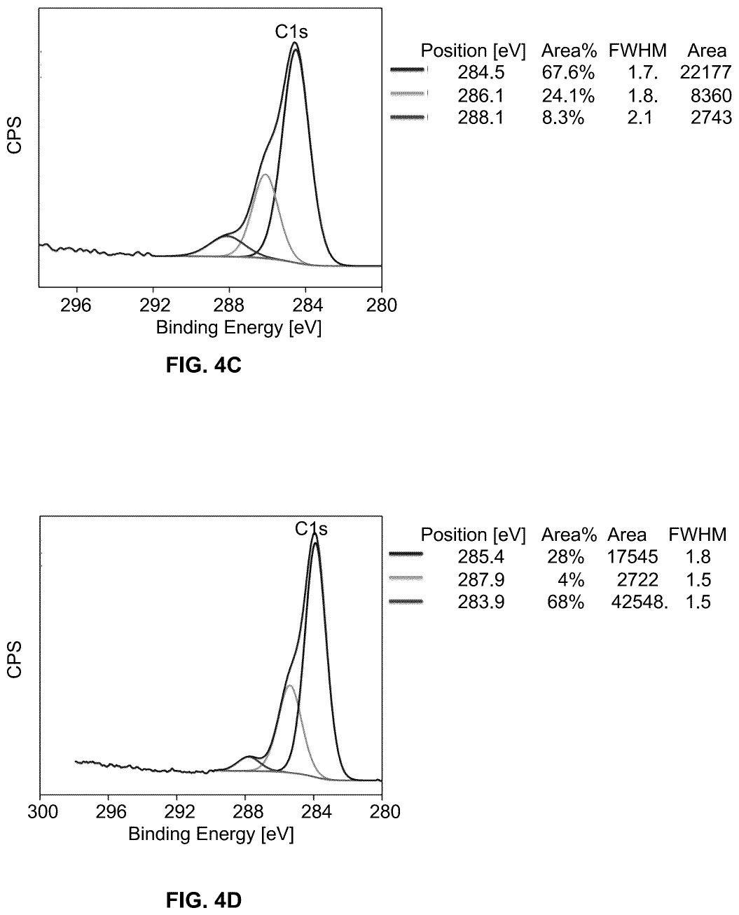

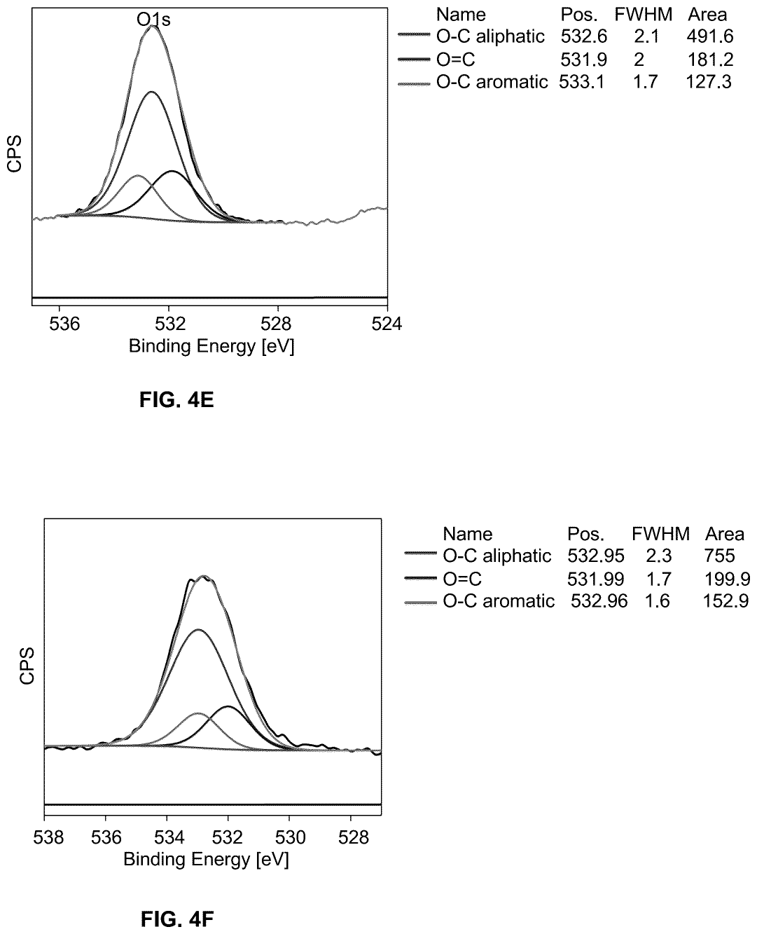

X-ray Photoelectron Spectroscopy (XPS) was performed on bare fibers before and after exposing to the dielectric barrier discharge-generated plasma to see if the plasma exposure affected the surface chemistry of the fibers (37); the full spectrum is shown in FIGS. 4A-4B. The elemental composition of desized T700 unidirection carbon fibers before and after exposure to DBS generated plasma shown as C and O percentages for each type of carbon fiber are listed in Table 1.

TABLE 1
Elemental composition of desized T700 unidirection carbon fibers

| Sample | C % | O % |
|---|---|---|
| CF before plasma exposure | 84.9 | 14.1 |
| CF after plasma exposure | 80.4 | 19.6 |

The deconvoluted C1s spectra (FIGS. 4C-4D) shows that there are no significant changes in the surface functionality of the carbon fibers after exposing to plasma; the relative contents of the functional groups on surfaces of desized T700 unidirectional carbon fibers exposed to different dielectric barrier discharge generated plasma determined by deconvoluted C1s XPS spectra are listed in Table 2, and similar functional groups are observed on the fiber surface before and after plasma exposure; deconvoluted O1s spectra is shown in FIGS. 4E-4F.

TABLE 2
Relative contents of functional groups

| Sample | C—C % | C—O—C % | O—C═O % |
|---|---|---|---|
| CF before plasma exposure | 68 | 28 | 4 |
| CF after plasma exposure | 68 | 24 | 8 |

Thus, DBD-generated plasma can be used for processing of carbon fiber composites and prepregs without affecting the interfacial properties between the fiber and the matrix.

### EXAMPLE 3

### Fabrication of Prepregs Using DBD

Unidirectional T700 fibers were impregnated with a two-part thermosetting epoxy (EPON 828 and Jeffamine T403), and the entire system was exposed to the DBD-generated plasma. The duty cycle of the plasma was modulated such that a target temperature of 120° C. was achieved for the fiber-resin system. Keeping the temperature constant, the plasma exposure time was varied from one minute to five minutes, such that composites with varying degrees of cure were fabricated.

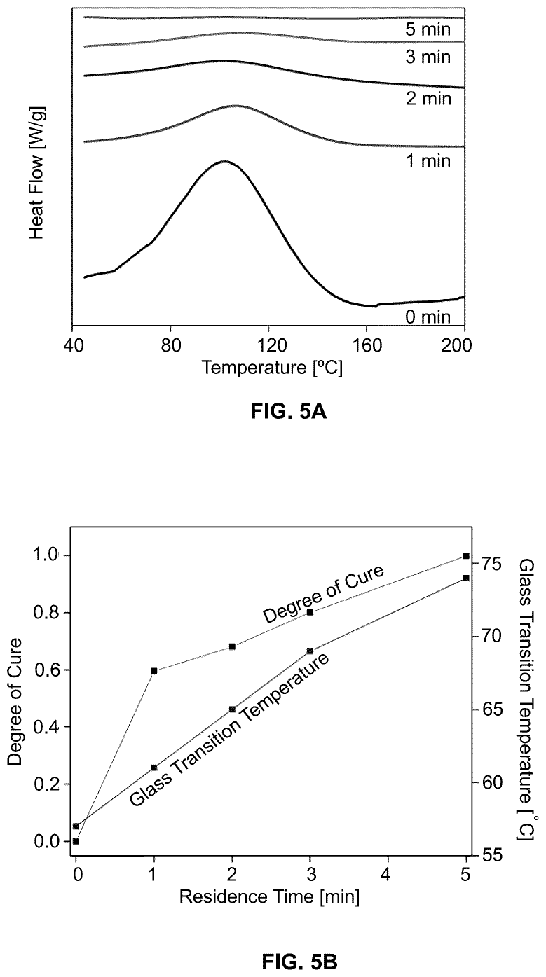

Differential scanning calorimetry was performed to determine the degrees of cure and glass transition temperatures of the resin-fiber systems cured for different exposure times (FIG. 5A). The area under the exotherm in the differential scanning calorimetry plot for samples with different exposure times was measured and compared against the area under the exotherm for a completely uncured sample to measure the degree of cure (38). The mathematical relation is

α=1−ΔHₜ/ΔH₀,

where α is degree of cure, ΔHₜ is the heat released during curing (obtained by area under the exotherm in differential scanning calorimetry plot) of a sample with plasma exposure time t, and ΔH₀ is the heat released during curing of a completely uncured sample.

The degrees of cure (α) and glass transition temperatures (T_{g}) of resin-fiber systems exposed to plasma for different residence times are shown in FIG. 5B. By controlling the residence time in the dielectric barrier discharge at the target temperature, composites and prepregs of varying degrees of cure were successfully fabricated using plasma-induced heating and curing of carbon fibers impregnated with thermosetting epoxy. In order to ensure that samples exposed to plasma did not undergo room temperature curing between heating experiments and differential scanning calorimetry testing, the samples were stored in a freezer at −18° C.

### EXAMPLE 4

### Patching of Damaged Composites

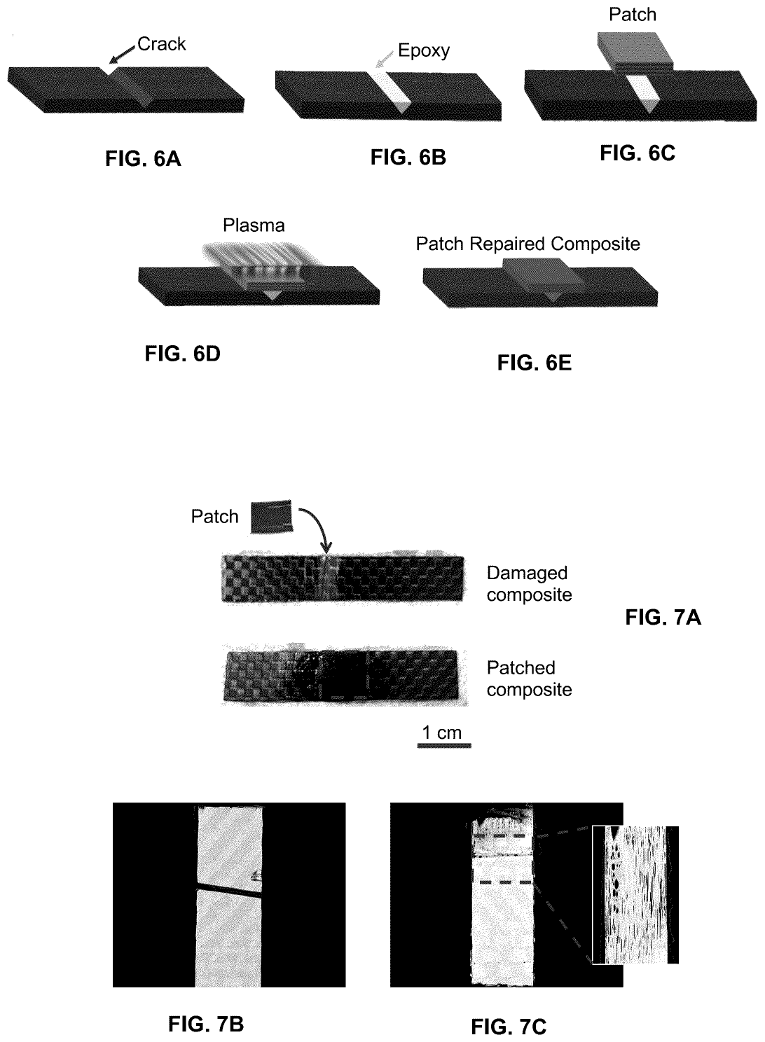

The application of dielectric barrier discharge-generated plasma-induced heating and curing for patch repair of damaged carbon fiber composites is illustrated in FIGS. 6A-6E. In order to repair such damages, first the damaged area, or crack (FIG. 6A), was filled with liquid, thermosetting epoxy (EPON 828 and Jeffamine T403) (FIG. 6B). The epoxy fills the damaged area and helps lower the stress concentration in the crack, thus preventing the crack from propagating any further. Next, a unidirectional T700 carbon fiber prepreg patch was placed over the damaged area (FIG. 6C), and the entire assembly was placed under the dielectric barrier discharge applicator. The carbon fibers in the prepreg heat up when exposed to the DBD-generated plasma (FIG. 6D), which heats and induces crosslinking in the surrounding epoxy, essentially curing the patch over the damaged area to form a patch repaired composite (FIGS. 6E, 7A). This patch acts as a structural additive to the damaged composite.

Five such damaged samples were repaired using plasma-induced heating and curing, and their mechanical properties were analyzed. The morphology of the damaged composites was analyzed before and after repair using micro-CT scan (FIGS. 7B-7C). FIG. 7B shows the cracked, damaged composite. FIG. 7C shows the damaged composite post-repair where the crack has been successfully filled and repaired by the plasma-cured patch, thus preventing further propagation.

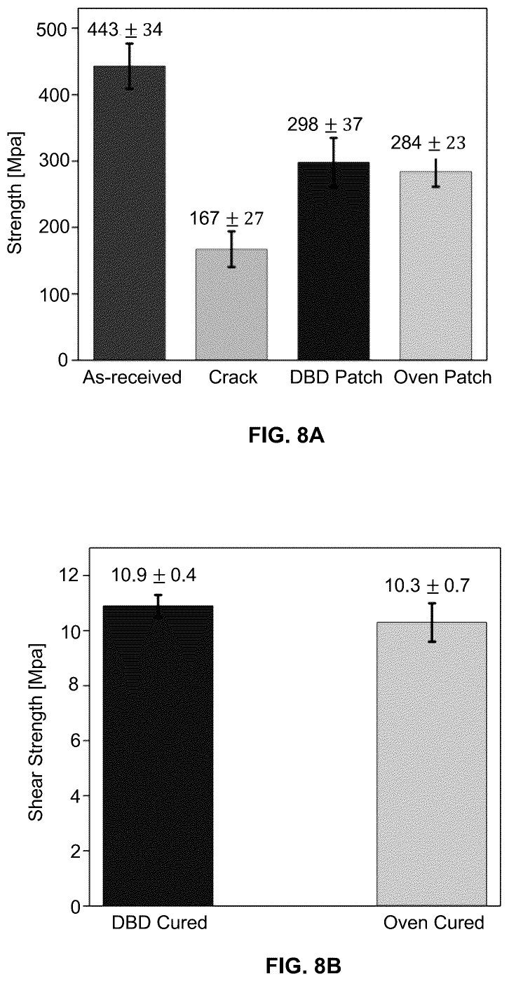

Next, mechanical testing was performed on plasma-repaired composites to determine their strength and compare it against the strength of damaged composites and as-received composites (FIG. 8A). The plasma-repaired composites also were compared against composites repaired using conventional oven curing. Composites repaired using plasma-induced heating and curing had a mechanical strength ˜78% higher than the damaged composite. Composites repaired using conventional oven heating also exhibited a similar recovery in mechanical strength (˜70%); thus, volumetric plasma-induced heating can be used for patch repairs of damaged composites, with the performance of repaired composites comparable to those repaired using conventional methods. The lap shear strength of the patch was measured by bonding a partially cured patch onto a fully cured composite, using either plasma-induced heating or conventional oven heating. Five samples of each type were tested, and similar shear strength values were observed for samples cured using either heating method (FIG. 8B). This data indicates that the adhesive strengths of the patches cured using either heating method are comparable. The present invention establishes plasma-induced heating and curing as a feasible methodology for patch repair of damaged composites. It is noted that thicker samples would require higher power to achieve coupling between the plasma and the sample.

### References

1. Figueiredo J L, Bernardo C A, Baker R, and Hüttinger K. (eds), Carbon Fibers Filaments and Composites. Vol 177: Springer Science & Business Media, 2013.
2. Adam H. Materials & Design, 18(4):349-355, 1997.
3. Minus M, Kumar S. JOM, 57(2):52-58, 2005.
4. Chung D D, Chung D. Carbon Fiber Composites, Elsevier; 2012.
5. Cheng et al. Composite Structures, 93(2):582-589, 2011.
6. Lai et al. Composite Structures, 235:111806, 2020.
7. Soutis et al. Composite Structures, 45(4):289-301, 1999.
8. Mohammadi et al. Journal of Reinforced Plastics and Composites, 40(1-2):3-15, 2020.
9. Bendemra et al. Composite Structures, 130:1-8, 2015.
10. Jones et al. Engineering Failure Analysis, 2(2):117-128, 1995.
11. Chong et al. Composites Part A: Applied Science and Manufacturing, 107:224-234, 2018.
12. Soutis C, Hu F. AIAA Journal, 38(4):737-740, 2000.
13. Whittingham et al. Composites Part A: Applied Science and Manufacturing, 40(9):1419-1432, 2009.
14. Caminero et al. Composite Structures, 95:500-517, 2013.
15. Charalambides et al. Composites Part A: Applied Science and Manufacturing, 29(11):1371-1381, 1998.
16. Kashfuddoja M, Ramji M. Materials & Design (1980-2015), 54:174-183, 2014.
17. Katnam et al. Progress in Aerospace Sciences, 61:26-42, 2013.
18. Pantelakis et al. Science China Physics, Mechanics and Astronomy, 57(1):2-11, 2014.
19. Shams S S, El-Hajjar R. F. Composites Part A: Applied Science and Manufacturing, 49:148-156, 2013.
20. Collinson et al. Composites Part C: Open Access, 9:100293, 2022.
21. Nele et al. Factories of the Future in the Digital Environment. 2016;57:241-246.
22. Liu et al. Composite Structures, 230:111529, 2019
23. Chae et al. Composites Research, 31(1):1-7, 2018.
24. Wang et al. International Journal of Fatigue, 148:106237, 2021.
25. Dasari et al. Adv Eng Mater. 25(10), 2023.
26. Vashisth et al. Nanoscale Advances, 3(18):5255-5264.
27. Vashisth et al. Composites Science and Technology, 195:108211, 2020.
28. Sarmah et al. Composites Part A: Applied Science and Manufacturing, 164:107276, 2023.
29. Sarmah et al. Chemsuschem, 15(21), 2022.
30. Sarmah et al. Advanced Engineering Materials, 24(7):2101351, 2022.
31. Sarmah et al. Carbon, 200:307-316, 2022.
32. Patil et al. Advanced Engineering Materials, 21(8):1900276, 2019.
33. Sweeney et al. Acs Appl Mater Inter, 10(32):27252-27259, 2018.
34. Debnath et al. Carbon, 169:475-481 2020.
35. Sweeney et al. Nano Letters, 20(4):2310-2315, 2020.
36. Mujin et al. Composites Science and Technology, 34(4):353-364, 1989.
37. Keenan M R. Journal of Applied Polymer Science, 33(5):1725-1734, 1987.

What is claimed is:

1. A method for repairing a composite material, comprising:
applying an epoxy to an area of the composite material in need of repair;
covering the area with an epoxy-filled patch; and
curing the epoxy electromagnetically, thereby repairing the composite material.

2. The method of claim 1, wherein the curing step comprises:
exposing the composite material and the epoxy-filled patch to a plasma produced by an electromagnetic applicator;
heating inductively via the plasma the composite material and the epoxy-filled patch; and
transferring heat from the composite material and the epoxy-filled patch to the epoxy contained therein to cure the same.

3. The method of claim 2, wherein the electromagnetic applicator is a dielectric barrier discharge applicator.

4. The method of claim 3, wherein the dielectric barrier discharge applicator comprises:
a pair of electrodes; and
a dielectric layer and an air gap positioned to separate the electrodes so that current flowing through the pair of electrodes flows through the dielectric layer to generate the plasma.

5. The method of claim 3, wherein the dielectric barrier discharge applicator is a hand-held dielectric barrier discharge applicator.

6. The method of claim 3, wherein the dielectric barrier discharge applicator does not make physical contact with the composite material during the exposing step.

7. The method of claim 1, wherein the composite material is a unidirectional carbon fiber reinforced composite material, a crossweaved carbon fiber reinforced composite material, or a hybrid composite consisting of carbon fibers and carbon nanomaterials.

8. The method of claim 1, wherein the epoxy-filled patch is made of a carbon fiber material, a heat-sensitive thermosetting epoxy, or nanomaterials for additional reinforcement.

9. The method of claim 1, wherein the area of the composite material in need of repair is repaired in situ.

10. The method of claim 1, wherein the composite material in need of repair is a component of a 3-dimensional composite part.

11. A layup manufacturing process of a composite part, comprising:
applying an epoxy to a first layer of composite material;
laying a second layer of composite material onto the first layer to shape the composite material as a layup, said epoxy disposed between said first layer and said second layer; and
heating the epoxy to cure it to bond the first layer to the second layer in the layup to form the composite part.

12. The layup manufacturing process of claim 11, wherein the heating step comprises:
positioning a dielectric barrier discharge applicator proximal to the layup, said dielectric barrier discharge applicator comprising a pair of electrodes with a dielectric layer and air gap positioned therebetween;
heating resistively the composite material in the layup with a plasma produced when an electric current is applied across the pair of electrodes in the dielectric barrier discharge; and
transferring heat from the composite material in the layup to the epoxy to cure the same in the shape of the composite part.

13. The layup manufacturing process of claim 12, wherein the dielectric barrier discharge applicator is stationary.

14. The layup manufacturing process of claim 12, wherein the dielectric barrier discharge applicator is movable relative to the layup.

15. The layup manufacturing process of claim 12, wherein the dielectric barrier discharge applicator is a hand-held dielectric barrier discharge applicator.

16. The layup manufacturing process of claim 12, wherein prior to the heating step, the method further comprises:
repeating the applying step and the laying step at least once until the composite material is shaped as the composite part.

17. The layup manufacturing process of claim 12, wherein the composite material is a carbon fiber reinforced composite material or a composite material filled with carbon nanotubes, carbon black or chopped fibers.

18. A system for manufacturing a 3-dimensional composite part, comprising:
a supply of a prepreg composite material stored on a spool;
a supply of an epoxy material;
an extruder configured to dispense the prepreg composite material and the epoxy material; and
a dielectric barrier discharge applicator positioned proximal to the extruder configured to generate a plasma to resistively heat the prepreg composite material and to cure the epoxy material as they are dispensed by the extruder, said 3-dimensional composite part formed thereby.

19. The system of claim 18, wherein the prepreg composite material is a carbon fiber reinforced composite material.

20. The system of claim 18, wherein the dielectric barrier discharge applicator comprises a pair of electrodes with a dielectric layer and air gap positioned therebetween.
